(19) United States
(12) Patent Application Publication
(10) Pub. No.: US 2017/0329455 A1
(43) Pub. Date: Nov. 16, 2017

(54) TOUCH PANEL AND TOUCH DISPLAY SCREEN

(71) Applicants: INTERFACE OPTOELECTRONIC (SHENZHEN) CO., LTD., Shenzhen (CN); GENERAL INTERFACE SOLUTION LIMITED, Miaoli County (TW)

(72) Inventors: JHE-WEI ZENG, Hsinchu (TW); WAN-CHUN WANG, Hsinchu (TW); YUE-FENG YANG, Hsinchu (TW); PO-LIN CHEN, Hsinchu (TW); YEN-HENG HUANG, Hsinchu (TW)

(21) Appl. No.: 15/193,119

(22) Filed: Jun. 27, 2016

(30) Foreign Application Priority Data
May 11, 2016 (CN) 201610308341.4

(51) Int. Cl. G06F 3/041; G06F 3/044

(52) U.S. Cl. CPC G06F 3/0418; G06F 3/044; G06F 3/0412; G06F 2203/04112; G06F 2203/04103

(57) ABSTRACT

A touch panel includes a substrate, a first electrode layer on a first surface of the substrate, and a second electrode layer on a second surface of the substrate. The first electrode layer has a plurality of first sensing lines configured to send touch signals and a plurality of first dummy lines coupled to the plurality of first sensing lines. The second electrode layer has a plurality of second sensing lines configured to receive the touch signals and a plurality of second dummy lines coupled to the plurality of second sensing lines. Each second dummy line defines at least one breaking point. Each first sense line has a projection at the second electrode layer which overlaps with one breaking point.

### FIELD

The subject matter herein generally relates to a touch panel and a touch display screen having the touch panel.

### BACKGROUND

Touch display screens are widely used. The touch display screen of an electronic device generally includes a display panel and a touch-sensitive layer. The touch-sensitive layer includes electrodes adapted to detect the touch on the touch display screen. Generally, the electrodes of the touch-sensitive layer are made of indium tin oxide, an expensive material.

### BRIEF DESCRIPTION OF THE DRAWINGS

Implementations of the present technology will now be described, by way of example only, with reference to the attached figures.

FIG. 1 is an isometric view of a touch display screen.

FIG. 2 is a cross-sectional view along line II-II of FIG. 1.

FIG. 3 is an isometric view of a touch panel.

FIG. 4 is a cross-sectional view along line IV-IV of FIG. 3.

FIG. 5 is a plan view of a first electrode layer of the touch panel of FIG. 3.

FIG. 6 is a plan view of a second electrode layer of the touch panel of FIG. 3.

FIG. 7 is a partial cross-sectional view of a touch-sensitive layer of the touch panel of FIG. 3.

FIG. 8 is another partial cross-sectional view of the touch-sensitive layer of the touch panel of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

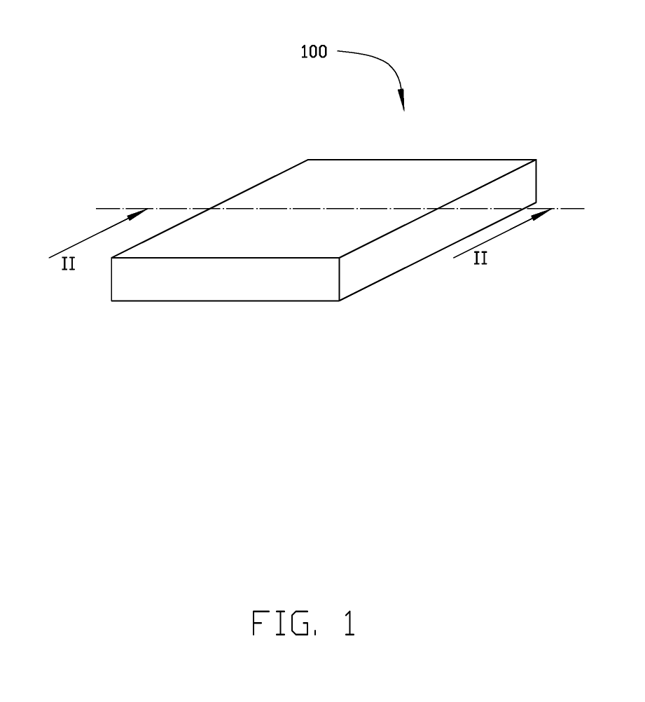

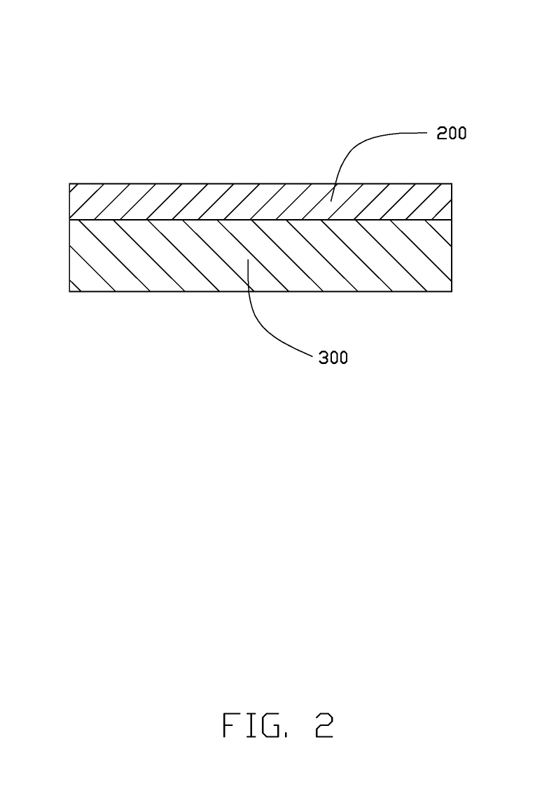

FIG. 1 and FIG. 2 illustrate a touch display screen 100. The touch display screen 100 comprises a touch panel 200 and a display panel 300 stacked on the touch panel 200. The display panel 300 is a commonly-used display panel, such as a liquid crystal display panel, an organic light-emitting diode display panel, a quantum dot display panel, or a plasma display panel.

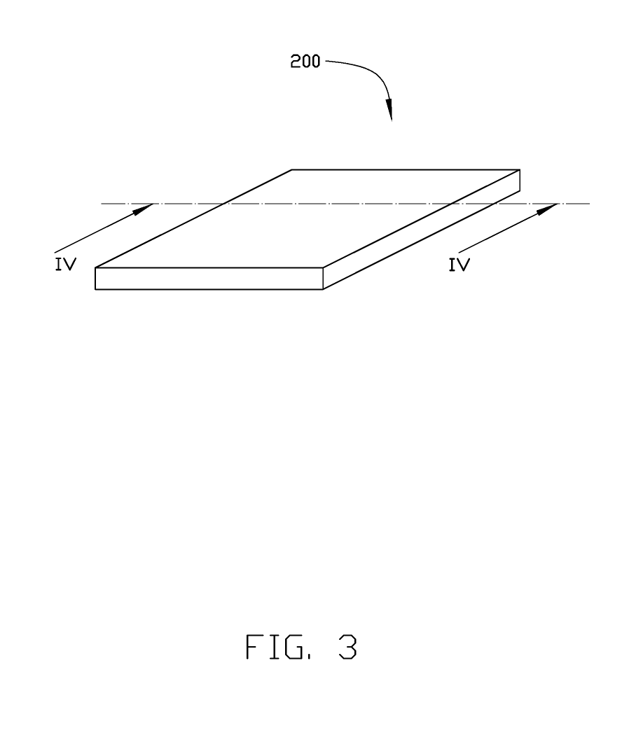

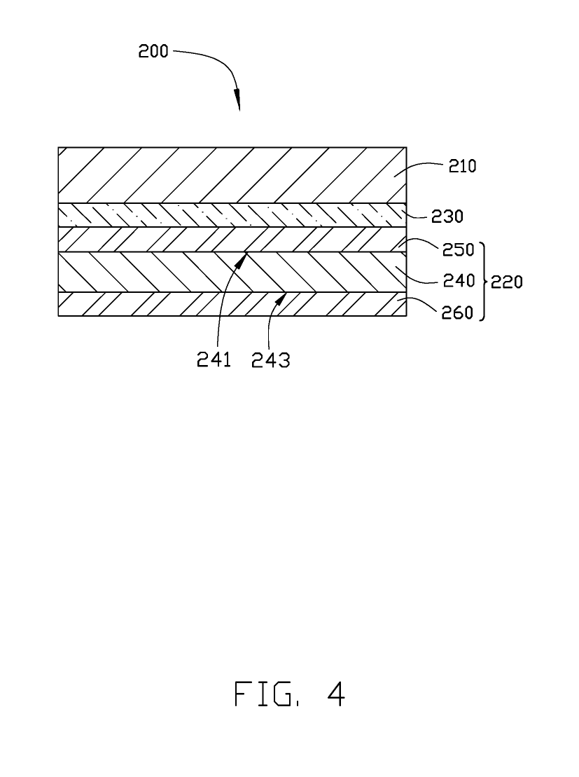

FIG. 3 and FIG. 4 illustrate that the touch panel 200 comprises a cover 210 and a touch-sensitive layer 220 attached to a surface of the cover 210 by an adhesive layer 230. That is, the adhesive layer 230 is positioned between the cover 210 and the touch-sensitive layer 220. The cover 210 may be made of a transparent material, such as glass or plastic. The adhesive layer 230 is made of a commonly-used optical clear adhesive.

The touch-sensitive layer 220 comprises a substrate 240, a first electrode layer 250 formed on a first surface 241 of the substrate 240 adjacent to the cover 210, and a second electrode layer 260 on a second surface 243 of the substrate 240 away from the cover 210.

In this embodiment, the first electrode layer 250 is configured to send touch signals, and the second electrode layer 260 is configured to receive touch signals. The first electrode layer 250 is electrically insulated from the second electrode layer 260.

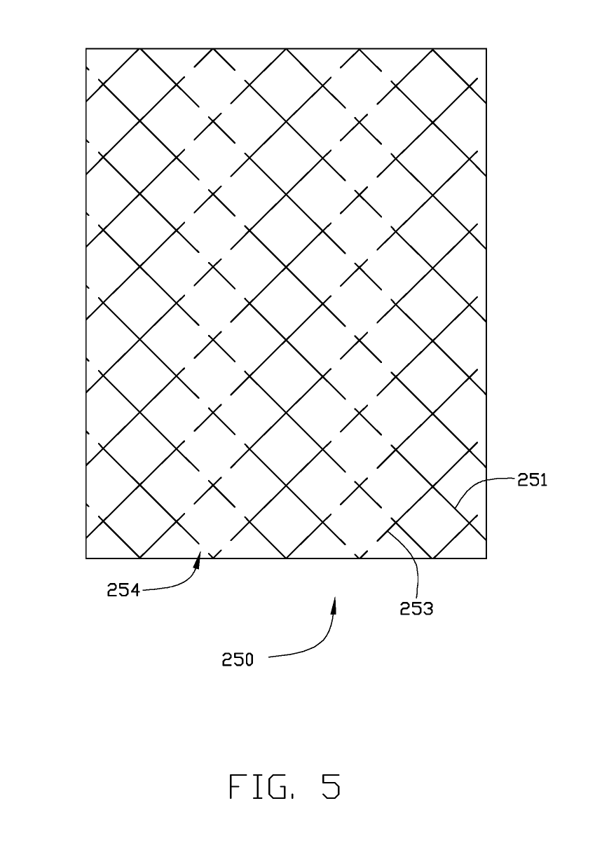

FIG. 5 illustrates the first electrode layer 250. The first electrode layer 250 comprises a plurality of first sensing lines 251 and a plurality of first dummy lines 253 coupled to the plurality of first sensing lines 251. The plurality of first sensing lines 251 is configured to send touch signals. The plurality of first dummy lines 253 is configured to reduce a moire effect on the touch panel 200. Each of the first dummy lines 253 defines at least one breaking point 254, and the at least one breaking point 254 divides the corresponding first dummy lines 253 into at least two separated portions. In this embodiment, each first sense line 251 couples to one first dummy line 253.

In this embodiment, the first sensing lines 251 and the first dummy lines 253 are made of a same conductive metal, such as copper. The first sensing lines 251 may be made by depositing a conductive metal layer, and etching and pattering the conductive metal layer, to form the first sensing lines 251. The first dummy lines 253 may also be made by depositing a conductive metal layer, and etching and pattering the conductive metal layer to form the first dummy lines 253. The first sensing lines 251 and the first dummy lines 253 can be made by a same process and be made of the same material. The etching method can be a photolithography etching method.

In this embodiment, each first sense line 251 is straight. The plurality of the first sensing lines 251 intersect to form a mesh. The mesh defines a plurality of rhombic structures arranged in columns. In other embodiment, each first sense line 251 can be a curved line; and the mesh can defines a plurality of structures of other shapes, such as rectangle or triangle structure.

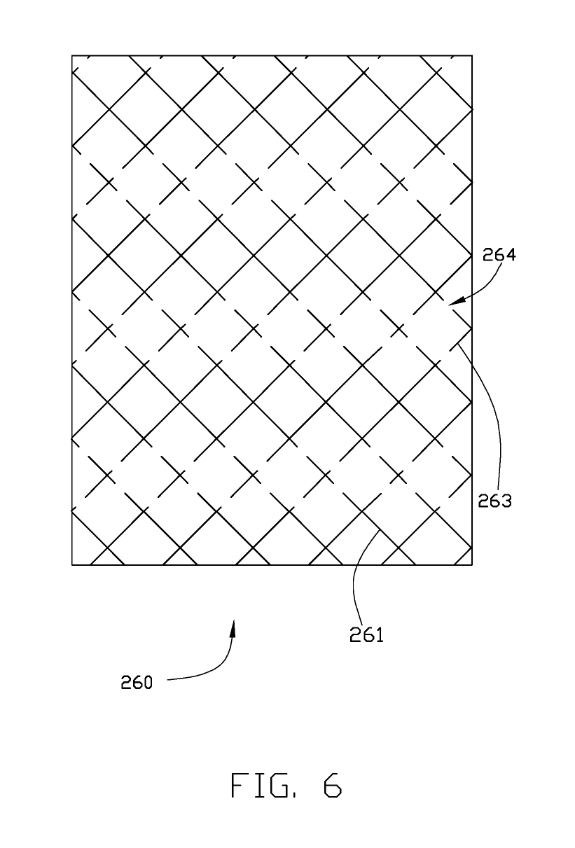

FIG. 6 illustrates the second electrode layer 260. The second electrode layer 260 comprises a plurality of second sensing lines 261 and a plurality of second dummy lines 263 coupled to the plurality of second sensing lines 261. The plurality of second sensing lines 261 is configured to receive the touch signals. The plurality of second dummy lines 263 is configured to reduce a moire effect of the touch panel 200. Each of the second dummy lines 263 defines at least one breaking point 264, and the least one breaking point 264 divides the corresponding second dummy lines 263 into at least two separated portions. In this embodiment, each second sense line 261 couples to one second dummy line 263.

In this embodiment, the second sensing lines 261 and the second dummy lines 263 are made of conductive metal. The second sensing lines 261 may be made by depositing a conductive metal layer, and etching and pattering the conductive metal layer to form the second sensing lines 261. The second dummy lines 263 may also be made by depositing a conductive metal layer, and etching and pattering the conductive metal layer to form the second dummy lines 263. The second sensing lines 261 and the second dummy lines 263 can be made by a same process and be made of the same material. The etching method can be a photolithography etching method.

In this embodiment, each second sense line 261 is straight. The plurality of the second sensing lines 261 intersects to form a mesh. The mesh defines a plurality of rhombic structures arranged in rows. In other embodiment, each first sense line 261 can be a curved line; and the mesh can defines a plurality of structures of other shapes, such as rectangle or triangle structures.

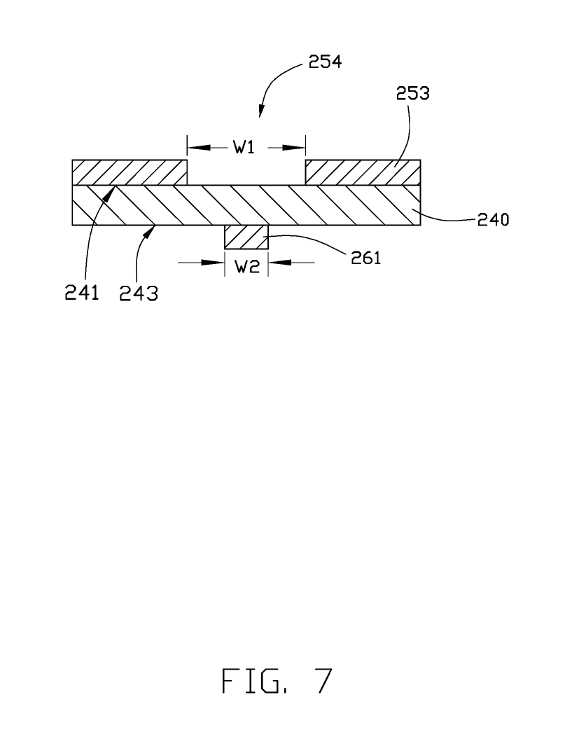

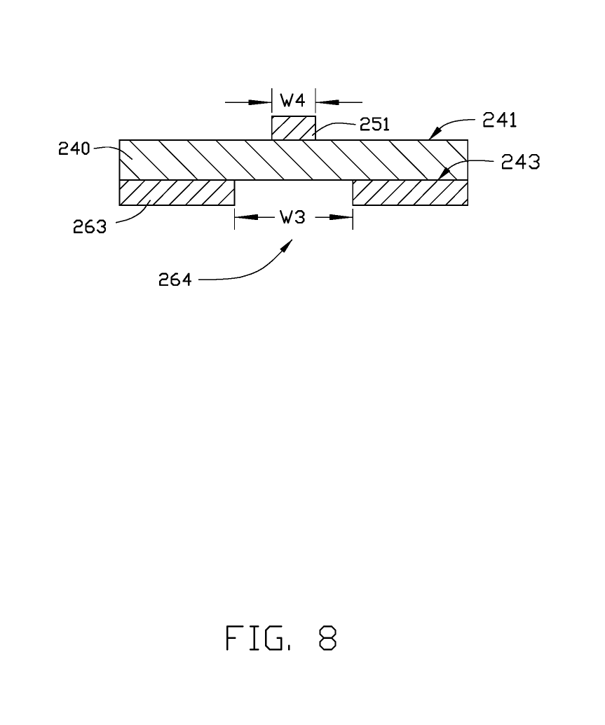

In this embodiment, the first sensing lines 251 have a projection at the second electrode layer 260 which is not entirely overlapped with the second sensing lines 261. That is, at least a portion of the projection of first sensing lines 251 is not overlapped with the second sensing lines 261. Each second sense line 261 has a projection at the first electrode layer 250 which intersects with one dummy line 253, as shown in FIG. 7. Each first sense line 251 has a projection at the second electrode layer 260 which intersects with one second dummy line 263, as shown in FIG. 8.

As shown in FIG. 7, the projection of each second sense line 261 at the first electrode layer 250 overlaps with one of the breaking points 254 of the first dummy lines 253. Every two separated portions of each first dummy line 253 divided by one breaking point 254 has a distance W1 along an extending direction of the corresponding first dummy line 253. That is, each breaking point 254 has a width W1 along an extending direction of the corresponding first dummy lines 253. Each second sense line 261 has a width W2 along a direction perpendicular to the lengthways extending direction of the second sense line 261. The distance W1 is not less than 1.5×W2, and is not greater than 5×W2. In at least one embodiment, the distance W1 is twice the width W2.

As shown in FIG. 8, the projection of each first sense line 251 at the second electrode layer 260 overlaps with one of the breaking points 264 of the second dummy lines 263. Every two separated portions of each second dummy line 263 divided by one breaking point 264 has a distance W3 along an extending direction of the second dummy line 263. That is, each breaking point 264 has a width W3 along an extending direction of the corresponding second dummy lines 263. Each first sense line 251 has a width W4 along a direction perpendicular to an lengthways extending direction of the first sense line 251. The distance W3 is not less than 1.5×W4, and is not greater than 5×W4. In at least one embodiment, the distance W3 is twice the width W4.

Each first dummy line 253 has two cross-sectional surfaces adjacent to the breaking point 254, and the two cross-sectional surfaces can be smooth or not smooth. For example, the two cross-sectional surfaces have a zigzag shape. Each second dummy line 263 has a two cross-sectional surfaces adjacent to the breaking point 264, and the two cross-sectional surfaces can be smooth or not smooth, such as zigzag. For example, the two cross-sectional surfaces have a zigzag shape.

The moire effect of the touch panel 200 can be effectively reduced due to the first dummy line 253 being on the first electrode layer 250 and the second dummy line 263 being on the second electrode layer 260. As the widths of each breaking point 254 and each breaking point 264 are set to be in reasonable ranges, parasitic capacitance on the touch panel 200 can be effectively reduced and touch position can be accurately detected.

The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A touch panel comprising:
a touch-sensitive layer comprising:
a substrate;
a first electrode layer on a first surface of the substrate, the first electrode layer having a plurality of first sensing lines configured to send touch signals and a plurality of first dummy lines coupled to the plurality of first sensing lines; and
a second electrode layer on a second surface of the substrate opposite to the first surface, the second electrode layer having a plurality of second sensing lines configured to receive the touch signals and a plurality of second dummy lines coupled to the plurality of second sensing lines;
wherein each of the plurality of first dummy lines defines at least one breaking point, each of the plurality of second dummy lines defines at least one breaking point, and each of the plurality of second sensing lines has a projection at the first electrode layer which overlaps with one of the breaking points of the first dummy lines.

2. The touch panel of claim 1, wherein each breaking point of the plurality of first dummy lines has a width W1 along an extending direction of the corresponding first dummy line; each second sense line has a width W2 along a direction perpendicular to a lengthways extending direction of the corresponding second sense line; and the width W1 is no less than 1.5×W2, and is no greater than 5×W2.

3. The touch panel of claim 2, wherein the width W1 is twice the width W2.

4. The touch panel of claim 1, wherein each of the plurality of first sensing lines has a projection at the second electrode layer which overlaps with one of the breaking points of the second dummy lines.

5. The touch panel of claim 4, wherein each breaking point of the plurality of second dummy lines has a width W3 along an extending direction of the corresponding second dummy line;
each first sense line has a width W4 along a direction perpendicular to a lengthways extending direction of the corresponding first sense line; and the width W3 is no less than 1.5×W4, and is no greater than 5×W4.

6. The touch panel of claim 5, wherein the width W3 is twice the width W4.

7. The touch panel of claim 1, wherein the touch panel further comprises a cover and an adhesive layer, the touch-sensitive layer is attached to a surface of the cover by the adhesive layer.

8. The touch panel of claim 7, wherein the first surface of the substrate is adjacent to the cover.

9. A touch panel comprising:
a touch-sensitive layer comprising:
a substrate;
a first electrode layer on a first surface of the substrate, the first electrode layer having a plurality of first sensing lines configured to send touch signals and a plurality of first dummy lines coupled to the plurality of first sensing lines; and
a second electrode layer on a second surface of the substrate opposite to the first surface, the second electrode layer having a plurality of second sensing lines configured to receive the touch signals and a plurality of second dummy lines coupled to the plurality of second sensing lines;
wherein each of the plurality of first dummy lines defines at least one breaking point, each of the plurality of second dummy lines defines at least one breaking point, and each of the plurality of first sensing lines has a projection at the second electrode layer which overlaps with one of the breaking points of the second dummy lines.

10. A touch display screen comprising:
a touch panel comprising:
a touch-sensitive layer comprising:
a substrate;
a first electrode layer on a first surface of the substrate, the first electrode layer having a plurality of first sensing lines configured to send touch signals and a plurality of first dummy lines coupled to the plurality of first sensing lines; and
a second electrode layer on a second surface of the substrate opposite to the first surface, the second electrode layer having a plurality of second sensing lines configured to receive the touch signals and a plurality of second dummy lines coupled to the plurality of second sensing lines;
wherein each of the plurality of first dummy lines defines at least one breaking point, each of the plurality of second dummy lines defines at least one breaking point, and each of the plurality of second sensing lines has a projection at the first electrode layer which overlaps with one of the breaking points of the first dummy lines.

11. The touch display screen of claim 10, wherein each breaking point of the plurality of first dummy lines has a width W1 along an extending direction of the corresponding first dummy line; each second sense line has a width W2 along a direction perpendicular to a lengthways extending direction of the corresponding second sense line; and the width W1 is no less than 1.5×W2, and is no greater than 5×W2.

12. The touch display screen of claim 11, wherein the width W1 is twice the width W2.

13. The touch display screen of claim 10, wherein each of the plurality of first sensing lines has a projection at the second electrode layer which overlaps with one of the breaking points of the second dummy lines.

14. The touch display screen of claim 13, wherein each breaking point of the plurality of second dummy lines has a width W3 along an extending direction of the corresponding second dummy line; each first sense line has a width W4 along a direction perpendicular to a lengthways extending direction of the corresponding first sense line; and the width W3 is no less than 1.5×W4, and is no greater than 5×W4.

15. The touch display screen of claim 14, wherein the width W3 is twice the width W4.

16. The touch display screen of claim 10, wherein the touch panel further comprises a cover and an adhesive layer, the touch-sensitive layer is attached to a surface of the cover by the adhesive layer.

17. The touch display screen of claim 16, wherein the first surface of the substrate is adjacent to the cover.
